(19) United States
(12) Patent Application Publication
(10) Pub. No.: US 2015/0012876 A1
(43) Pub. Date: Jan. 8, 2015

(54) SYSTEM, METHOD AND APPARATUS FOR DISCOVERING CONNECTIONS BASED ON PRIOR WORK

(71) Applicant: TheStreet, Inc., New York, NY (US)

(72) Inventors: Michael Crosby, South Orange, NJ (US); Jay Fox, Jersey City, NJ (US)

(73) Assignee: TheStreet, Inc.

(21) Appl. No.: 14/325,687

(22) Filed: Jul. 8, 2014

Related U.S. Application Data
(60) Provisional application No. 61/843,764, filed on Jul. 8, 2013.

(51) Int. Cl. G06F 17/30; G06F 3/0484

(52) U.S. Cl. CPC G06F 17/30991; G06F 3/0484
USPC 715/780

(57) ABSTRACT

Disclosed are systems, methods and apparatuses for the development of relevant connections among parties. A connections data set is developed from data sources that show meaningful relationships among parties. In the case of parties involved in the M&A field the data set is derived from M&A deals, from which companies, individuals and deals are collected. A user interface is further provided to efficiently search and display connection information.

### RELATED APPLICATIONS

The present invention claims all rights to U.S. Provisional Patent Application No. 61/843,764, filed on Jul. 8, 2013, which is hereby incorporated by reference.

### FIELD OF THE INVENTION

The present disclosure relates to computer-enabled systems for discovering connections useful for interpersonal networking, business development and strategic research.

### BACKGROUND

Computers, databases and networks have long provided a wealth of information that enables users to create connections between people and entities. The connections provided by this data have been widely put to use in online social networks and professional networks. Using these services, it is relatively easy for one to identify and develop thousands of connections. The quality and the usefulness of all those connections, however, are questionable.

### SUMMARY OF THE INVENTION

In view of the above deficiencies, the disclosed system seeks to provide meaningful and highly useful connections. This is accomplished by focusing the data set used to identify connections on highly relevant interactions between parties. By confining the source data to relevant interactions high-quality connections are identified and not lost in a large volume of less relevant connections.

One advantageous embodiment provides systems and methods for implementing a user interface of a connections finder. An information gathering display interface is presented. It further provides a first and second text entry interface to receive a party identifier on the information gathering display interface. The process continues by receiving the first party identifier from the first text entry interface and the second party identifier from the second text entry interfaces and queries a connections data set to determine whether there are connections between the first party identifier and the second party identifier. The data set contains information pertaining to a plurality of parties and one or more transactions that each of the parties has participated in. An information conveying display interface is provided for displaying any connections between the first party and the second party determined by the query. The presenting steps can optionally be embodied through the transmission of HTML data. The process may further include a check box interface or a radio button element associated with the text entry interfaces to identify whether the parties are persons or corporations. The process may further advantageously include an autocomplete feature wherein the displayed parties are organized by whether the displayed parties are persons or corporate entities. The autocomplete feature can function by examining the entered text letter by letter to compare the text being entered to the possible parties the text is intended to represent. The systems described above can be advantageously embodied by a web server for providing the described interface elements via HTML and in communication with a connections database. The systems can alternatively be embodied in an application, such as a mobile application that connects to the connections server over a network.

Another advantageous embodiment provides systems and methods for implementing a user interface of a connections finder. An information gathering display interface is presented. Content is provided on the information gathering display interface. A viewer of the information on the information gathering display interface is identified. The content is analyzed to identify one or more parties referenced in the content. A connections data set is queried to determine whether there are connections between the viewer and one or more of the parties referenced in the content. An information conveying display interface is presented displaying any connections between the viewer and one or more of the parties referenced in the content. The information conveying displaying interface may further identify one or more transactions in common between the viewer and one or more of the parties referenced in the content. The analyzing may advantageously include querying the connections database to identify the parties referenced in the content. The systems described above can be advantageously embodied by a web server for providing the described interface elements via HTML and in communication with a connections database. The systems can alternatively be embodied in an application, such as a mobile application that connects to the connections server over a network.

Additional inventive concepts and embodiments are described in the detailed description and claims.

### BRIEF DESCRIPTION OF THE FIGURES

FIGS. 1A, 1B and 1C show exemplary user interfaces in accordance with the present disclosure.

FIGS. 2A and 2B show exemplary user interfaces in accordance with the present disclosure.

FIGS. 3A, 3B and 3C show exemplary user interfaces in accordance with the present disclosure.

FIG. 4 shows an exemplary user interface in accordance with the present disclosure.

FIGS. 5A, 5B, 5C and 5D show exemplary user interfaces in accordance with the present disclosure.

FIG. 6 shows an exemplary user interface in accordance with the present disclosure.

FIGS. 7A and 7B show exemplary user interfaces in accordance with the present disclosure.

FIG. 8 shows an exemplary user interface in accordance with the present disclosure.

FIGS. 9A and 9B show exemplary user interfaces in accordance with the present disclosure.

FIG. 10 shows an exemplary user interface in accordance with the present disclosure.

FIGS. 11A and 11B show exemplary user interfaces in accordance with the present disclosure.

### DESCRIPTION OF THE INVENTION

In the context of professionals working in the finance industry, such as M&A bankers and lawyers, a valuable data set for discovering connections resides in the analysis of deal transactions. Participants to a deal (e.g., buyers, sellers, corporate development professionals, and legal counsel) have undertaken a substantial amount of work together thereby creating a strong foundation for a connection. Moreover, the professionals using a networking service are most likely interested in finding connections related to their work, i.e., current or future deals. Thus, connections arising from a party's work on prior deals are directly relevant to the user's interest. Collecting this information into a database serves to provide an advantageous data set to identify valuable connections. While the present disclosure is described in terms of deals in the financial industry, persons of skill in the art will be able to readily identify the most relevant data sets for applying the teachings herein to other domains.

The present system constructs a database for creating networking connections from records of deal transactions. For such a database the following information is advantageous to record: type of transaction, date, seller company, buyer company, officers and directors of both buyer & seller, banks providing financing, bankers, law firms and lawyers involved, proxy firms and related employees, valuation firms and related employees, audit firms and related employees, consulting firms and related employees, related advisors (bankers, lawyers) to principal investors (e.g. private equity firm or major debt-holder. The affiliation of lawyers, bankers, etc. to the parties they represent is also recorded. This information is stored in a structured data set using a database or other data organization techniques, as are known in the art. For example, the data is preferable stored in a relational database with appropriately defined and tagged fields.

With the data set stored, queries can be run across the data using known searching techniques to provide useful results. For example, a query could seek to show all the deals involving Jane Doe, or all the deals transacted in October 2010. It has been found, however, that the use of this data is advantageously provided by a user interface specifically designed to elicit useful queries and provide results that highlight the relevant information.

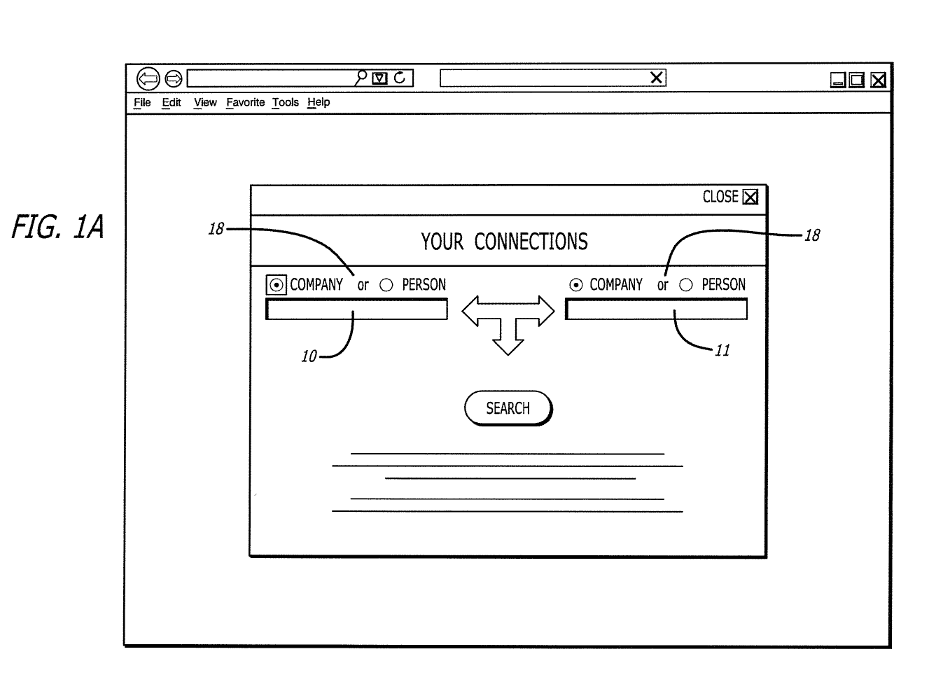

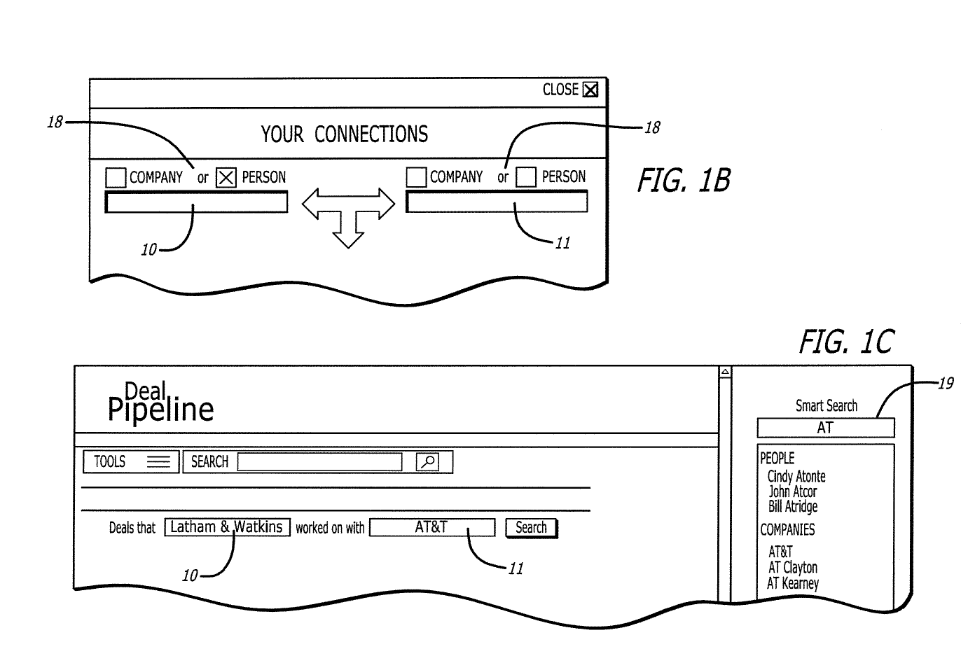

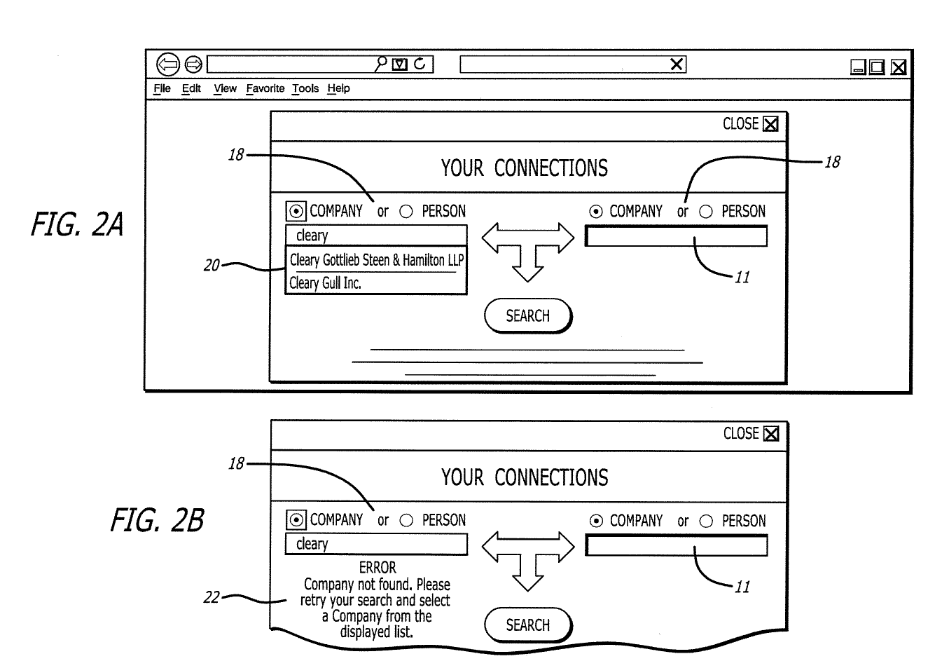

FIGS. 1A, 1B and 2A, 2B show exemplary web search interfaces for use with the disclosed system. The interface comprises two search boxes 10, 11 used to identify the entities the user would like to search connections between. The entities searched in the boxes are referred to as Party 1 and Party 2, herein respectively. In the FIGS. 1A and 1B embodiments, each search box optionally further comprises an associated radio button or checkbox 18 to identify whether the entity identified in the search box is a company or a person.

FIG. 1C shows an alternative embodiment that does not include the radio buttons or check boxes to distinguish between persons and companies. Instead, a smart search auto-complete interface is provided to identify entities matching the user's query and organizes the potential matches by company or person.

These approaches enable resolution of ambiguities between persons and companies. FIGS. 2A and 2B further show that the interface 20 will attempt to auto-complete the name of the entity being entered by the user. This is similar to the FIG. 1C embodiment but without the categorization by people or company. The person/company radio button or checkbox control or the autocomplete with categorization as in FIG. 1C serve to improve the accuracy of party identification. As shown in FIG. 2A, by selecting the “company” radio button the possible selections are narrowed to companies and law firms with the name Cleary as opposed to persons named Cleary. The auto completion features also advantageously signal to the user which entities have entries in the database. In other words, if the entity being searched for does not appear in the auto completion, it does not exist in the data set and a search will not be successful. An error message 22 will display if the search is not entered correctly or if user does not select a company from the dropdown before moving to the next search term.

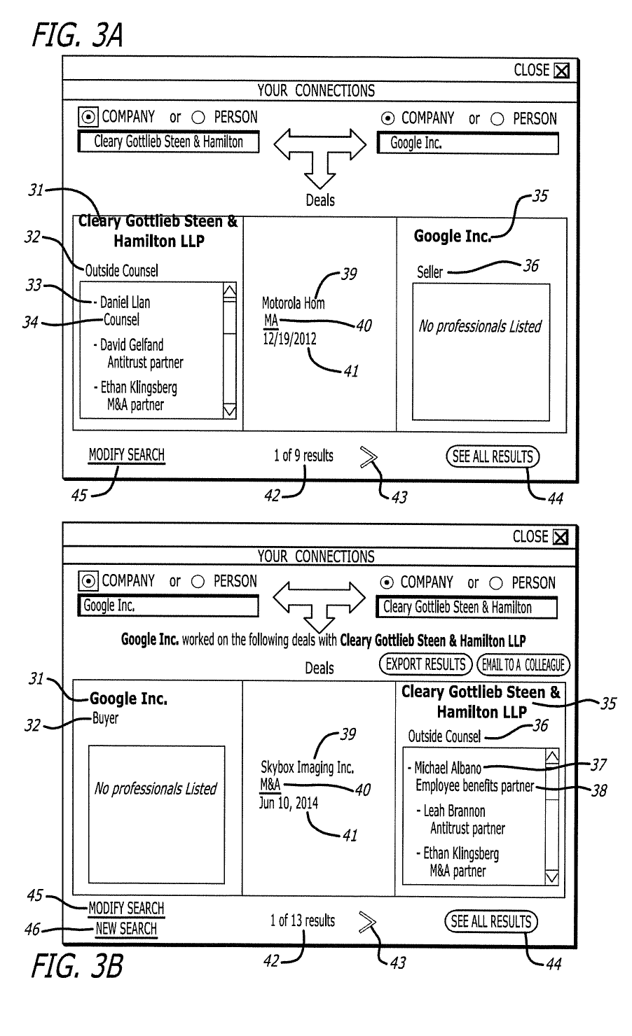

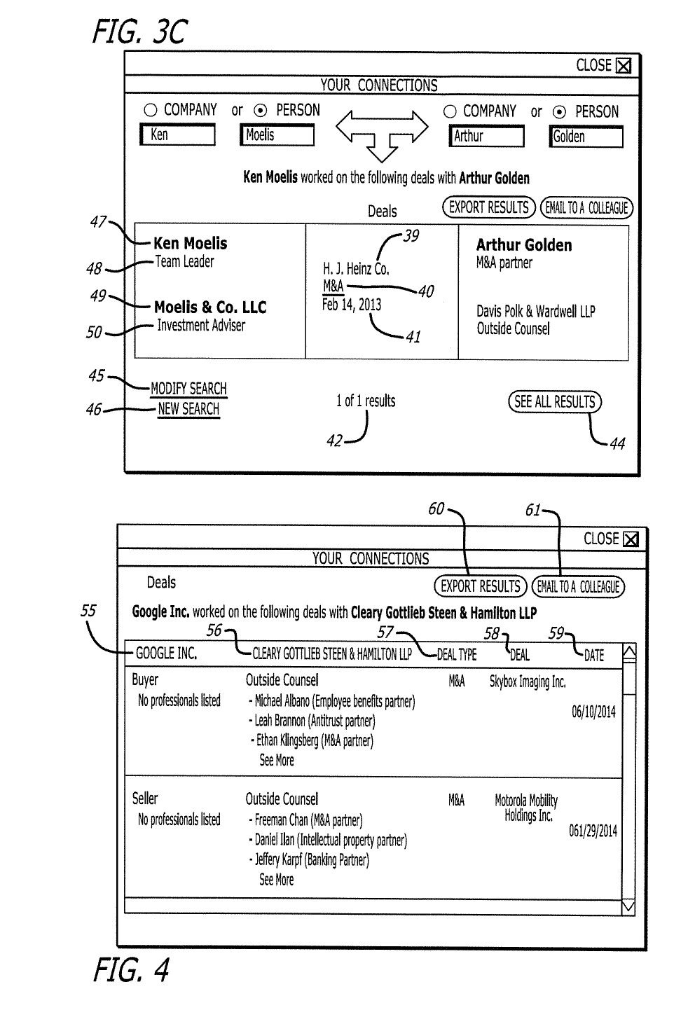

FIGS. 3A and 3B show an exemplary search results page for a Company-to-Company search where the database contains direct connections between the entities, i.e., the entities have participated with one another in a deal. The information displayed is extracted from the database and formatted in the webpage. For the first searched company (left box) the data shown is:

Company Name 31
Company Role 32
Person Name 33
Person Role 34

For the second searched company (right box) the data shown is:

Company Name 35
Company Role 36
Person Name 37
Person Role 38

The center box shows the results and in this case reflecting a deal involving the two parties with the following information:

Target Company Name 39
Deal Type 40
Announcement/Reference Date 41

Below the “deal” column is an identification 42 of the number of deals involving these two entities and an interface to browse the results 43. There are also interfaces to display all connections 44 and an option to modify the search parameters 45 or perform a new search 46.

An exemplary use of the interfaces shown in FIGS. 1-3 would occur as follows. A user clicks on the connections box on the top nav, which takes the user to the search interface. The default is to show neither radio button selected. The user selects company radio button and enters a company name in a search box. The user performs the same action in the second search box and clicks the “Search” button. Search results appear sorted by most recent deal. Clicking on company name in either left or right search box takes the user to a Company Page. Clicking on a person name in either left or right search box takes the user to a Person Page. Clicking on a subject entity company name takes user to a company page. Clicking on “modify search” or “new search” takes the user back to the search page. If modifying search is selected, the searched company names should remain until user clicks on either search box. Clicking on the box highlights the text, which user can then delete to start new search. If performing a new search, the searched company names disappear and a new search ensues.

FIG. 3C shows an exemplary search results page for a Person-to-Person search where the database contains direct connections between the people, i.e., the people have participated with one another in a deal. The data display for individuals is.

Name 47
Title 48
Company 49
Company Role 50

An exemplary use of the interfaces shown in FIGS. 1, 2, and 3 would occur as follows. A users clicks on the connections box on the top nav, which takes the user to the search interface. The default is to show neither radio buttons selected. The user selects the person radio button and enters a person name in search box. The user enters a second person's name in the second search box and clicks the “Search” button. The search results appear sorted by the most recent deal. Clicking on a person name in either the left or right search box takes the user to a Person Page. Clicking on a Company name in either the left or right search box takes the user to a Company Page. Clicking on a subject entity company name takes the user to a company page. Clicking on “modify search” or “new search” takes the user back to the search page. If modifying the search is selected, searched people names should remain until the user clicks on either search box. Clicking on the box highlights the text, which a user can then delete to start a new search. If performing a new search, searched people names disappear and a new search ensues.

FIG. 4 shows an exemplary interface for a detailed view of the search results if the “see all results” button of FIG. 3 is selected. The following information is provided:

“[Company Name from left search box] worked on the following deals with [Company Name from right search box].”

This is followed by the Table columns (which shows left to right):

[Company Name from left search box] 55
[Company Name from right search box] 56
Deal Type 57
Deal 58
Date 59

The interface of FIG. 4 further advantageously includes an interface element 61 to email the results and a further interface element 60 to export the results.

Company column cells can advantageously contain the company role for that deal. Indented below the company role, the first three employees at the company that worked on the deal are displayed with the employee role in parentheses. Preferably, the three most senior persons are listed. The employee names link to a Person profile page describing information about the person. For the sake of simplicity, it may be advantageous to list no more than three person names per company column cell. If more than three names from that company are associated with the deal a “see more” link should be displayed at the bottom of the cell which would link to a deal description page that provides full information about the deal including all recorded employees. If there are no employees, the text “No Professionals Listed” should appear.

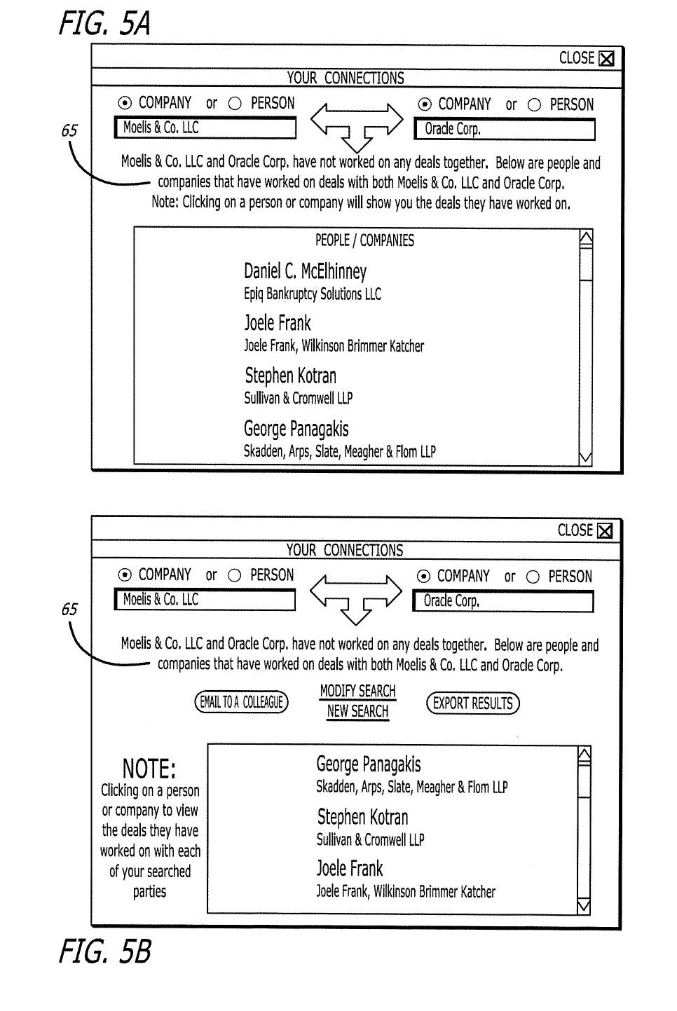

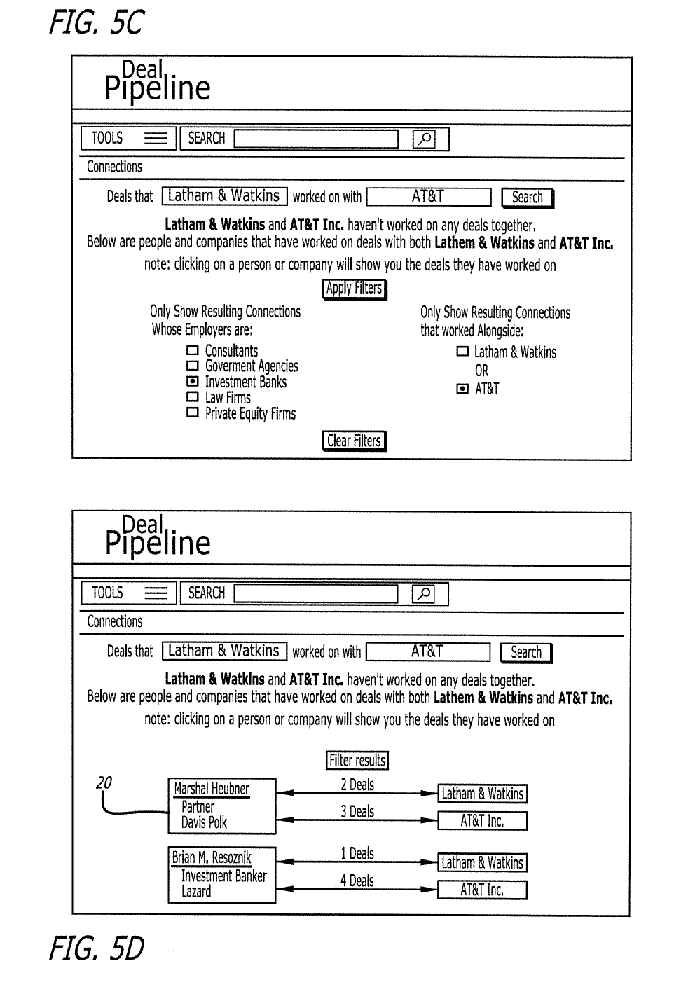

FIGS. 5A and 5B show an exemplary interface for a search results page for Company-to-Company search where there are only indirect connections between the entities. In other words, this displays information where the two entities have not participated on a deal together, but where there exists in the database companies or people that have worked on deals with both of the searched entities. The interface advantageously provides text 65 explaining “[company name] and [company name] have not worked on any deals together. Below are people and companies that have worked on deals with both [company name] and [company name].

In a currently preferred embodiment, ten results will appear per page with page navigation links below the results. Other numbers of results can be displayed at the option of the implementer of the disclosed system.

FIG. 5C shows an alternative embodiment for a “filtering” mechanism on the indirect search results page whereby the user can filter the results by the type of employer (Consultants, Investment Banks, Law Firms, PE Firms, Proxy, PR, etc.) and by which side the indirect connection worked on (with search term Party 1 or search term Party 2).

FIG. 5D shows a further embodiment of the results page for indirect search results. For each indirect connection 70, the number of deals with each searched entity are shown. FIG. 5D also includes a filter results control 51 that activates a result filter such as is in shown in FIG. 5C.

An exemplary use of the interfaces shown in FIGS. 1-2 and 5 would occur as follows. A user clicks on connections box on top nav, which takes the user to the search interface. The default is to show no radio buttons selected. The user selects the “company” radio button and enters a company name in the search box. The user performs the same action for the second search box and clicks the “Search” button. Search results appear sorted by the most recent deal with people common to both searched companies; then by most recent deal with companies (without people) named in the deal. Clicking on the company or person name in center box takes the user to indirect detailed results for that company or person.

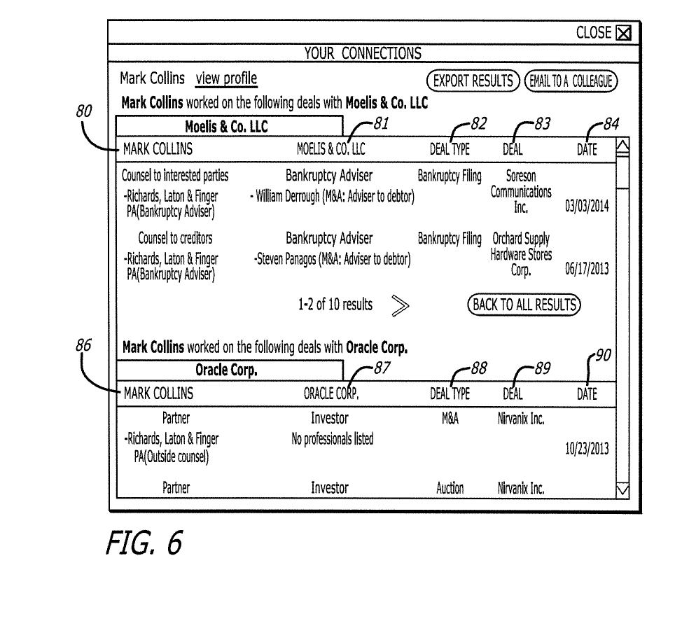

FIG. 6 shows an exemplary interface for a detailed view of Company-to-Company indirect connections.

An exemplary use of the interfaces shown in FIGS. 1-2 and 5-6 would occur as follows. A user clicks on a name of company link in the indirect simple view popup to get to the detailed view of that entity. A detailed view then replaces the simple view popup. The indirect detailed view contains searched companies in two tabs and shows the deal information.

The indirect detail view displays results between the company in first search box and the indirect person/company and the results between the company in second search box and the indirect person/company.

If a user clicked on a person in simple view, the first column (Person/Company Role) has the name of the person, his company name, and a company role. If the user clicked on a company in simple view, the first column (Person/Company Role) has the name of the company and the company role. The first column would link to the person profile when the result is a person and the company profile when the result is a company.

As shown in FIG. 6, the Company or Person name selected from Indirect Search simple view appears in top left with the text “View Profile” that links to the company or person profile page.

Results are divided into two tables, each with a separate page navigation. The following text will appear above the first table:

“[Company or Person name selected Indirect Search—simple view] worked on the following deals with [Company Name from left search box].”

The column headings for the first table will be:

[Company or Person name selected Indirect Search - simple view] 80
[Company Name from left search box] 81
Deal Type 82
Deal 83
Date 84

The second column (Searched company/person) has name of the searched company and the company role; the third column (Deal Type) lists the deal type such as M&A, Auction, or Bankruptcy; the fourth column (subject entity) is the target (M&A/Auction) or Debtor (Bankruptcy) and the fifth column (Date) is the reference date.

Preferably, the table displays up to three results at a time, with navigation to view the next three, etc. To the right of the navigation is a link “Back to all results” that returns the user to the previous Indirect simple search results page. To get back to simple view user clicks a “Back to all results” interface element or a back arrow icon in the top left corner to get to the original list. A line or other border separates the first and second tables. The text that will appear above the second table, which relates to the second company or person searched:

“[Company or Person name selected Indirect Search—simple view] worked on the following deals with [Company Name from right search box].”

The column headings for the second table are:

[Company or Person name selected Indirect Search - simple view] 86
[Company Name from right search box] 87
Deal Type 88
Deal 89
Date 90

Preferably the table displays up to three results at a time, with navigation to view the next three, etc. To the right of the navigation is a link “Back to all results” that returns the user to the previous Indirect simple search results page. Company column cells contain the company role for that deal. Indented below the company role, the first three employees are displayed with the employee role in parentheses. The employee names link to the Person profile page. Preferably, no more than three person names should be listed per company column cell. If more than three names from that company are listed in that deal, a “see more” link is displayed at the bottom of the cell, which links to a page describing the details of the deal at issue. If there are no employees, the text “No Professionals Listed” is shown.

Person column cells contain the person role for that deal. Indented below the person role, the company name can be displayed with the company role below in parentheses.

The results pages described above can optionally contain an “Email a colleague” control. When activated the feature will generate an email with preformatted text directing the recipient to the discovered connection. Similar information could be conveyed through other mediums such as text message, IM, twitter, social media, etc. Exemplary text for such a message could read:

Subject line - View this connection from The Deal Pipeline
Body - Hi! I thought you'd be interested to see this connection between
[Company/Person searched from left search box] and [Company/Person
searched from right search box]:
URL to simple direct or indirect connection result
The Deal Pipeline's new Connections tool shows you the people and
companies that you are connected to via common deal work.

The results page can further provide an “Export Results” control that exports the tables as an Excel spreadsheet, comma separated value file, XML file, or the like. The file contains the information shown in the results page but also includes that data for all results.

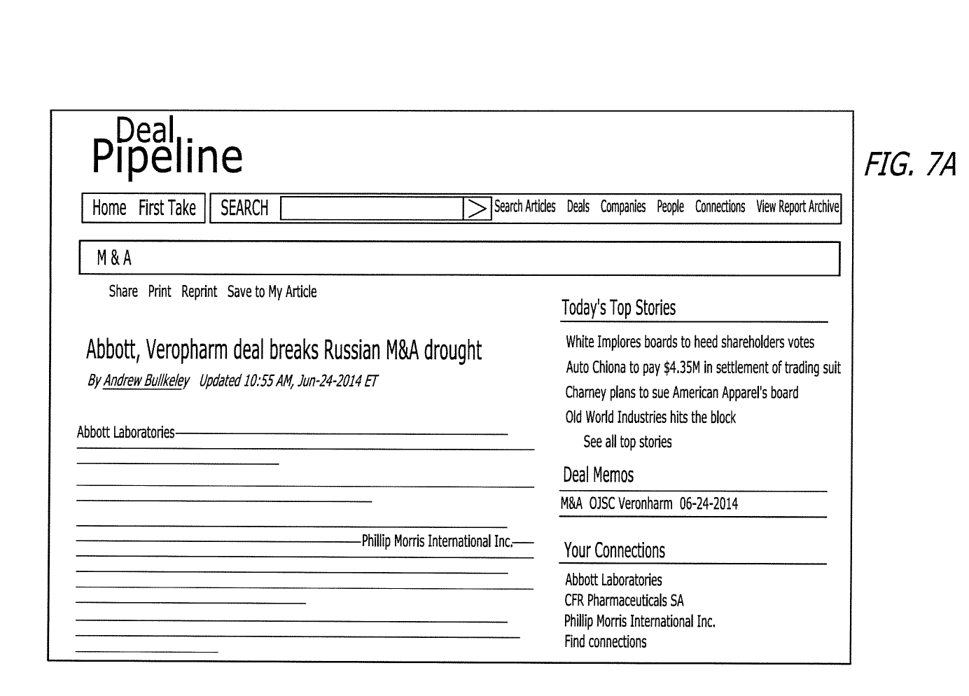

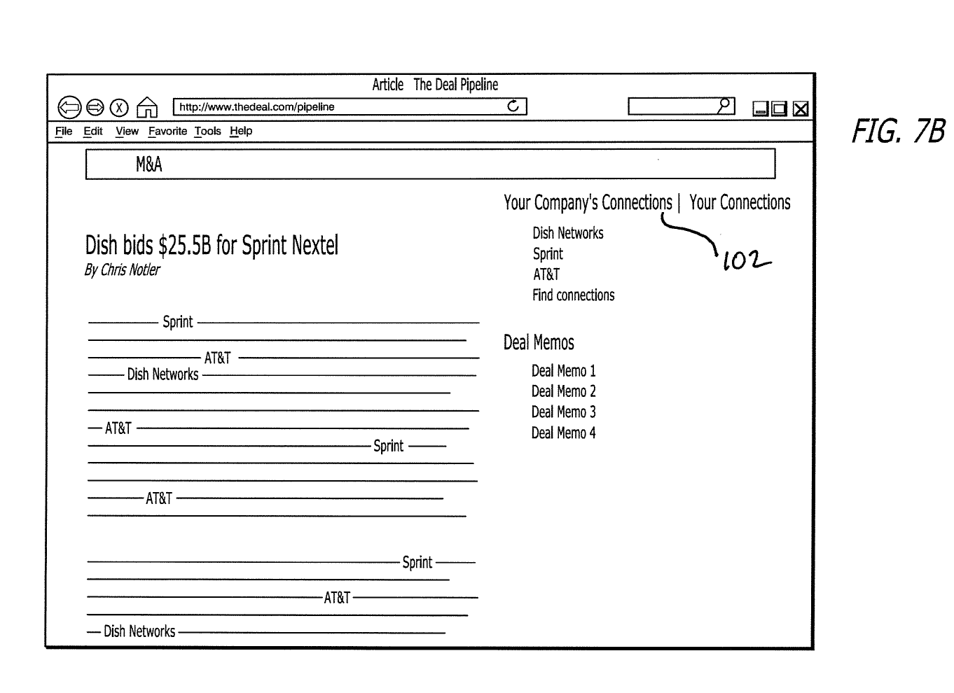

FIG. 7A demonstrates Guided Search. Guided search provides automated input into the search system of the present disclosure to allow users to discover connections without having to actively seek them out. A user logged in to the system will have a personal ID, associated with that ID will be a personal profile page that contains information about the person, such as their name and company affiliation (and optionally, prior company affiliations). When the user browses informational content such as news articles, company profiles, or person profiles, Guided Search will look for connections in the background between the user and entities mentioned in the content the user is viewing.

Preferably, the informational content is tagged to identify entities that are recorded in the deal database. For example, in FIG. 7A a number of entities in the news article shown are tagged (see, e.g., Abbott Labs and Philip Morris). Note for the sake of simplicity the text content of the article in the figures is shown as lines. In an actual implementation, this would be the content of the news article. The tags could be created using standard mark up techniques, such as XML or HTML, and would identify the entities and could be added when the article is created. Alternatively, processes could be used to identify relevant entities without tags. For example, when an article is posted an entity identifier process could scan the article for entities matching database entities and add links, accordingly. Guided search runs a number of queries for connections between the user and each of the tagged entities in the article. Any connections identified are displayed on the same page as the page being viewed in the “Your Connections” frame. Available connections are preferably formatted as follows: “[COMPANY NAME] or [PERSON NAME]”. When a user clicks on the connection it will take her to the simple search results between herself and the selected COMPANY or PERSON (either direct, such as in FIG. 3 or indirect, such as in FIG. 5). Returning to FIG. 7A, if the user wishes to perform a manual search a “Find connections” link is provided to take the user to the default search page.

As demonstrated in FIG. 7A, the view more connections content may be used to show indirect connections. In some ways, indirect connections may be more interesting in the context of a user's own connections because a user is likely to know about his or her own direct connections. Thus, indirect connections may be more illuminating than direct connections. It may be useful to display these indirect connections even when the user has direct connections with the entities listed because it allows user to find commonalties with their colleagues. In a further embodiment, shown in FIG. 7B, an interface control 102 is provided to allow the user to switch between personal connections and connections based on their company.

Even if the user is not logged in personally to the system, other information could be used to discover connections. For example, the user's company could be identified, for example through an IP address or cookie, or company level login. In that case, Guided Search would then perform searches between the user's Company and the other entities mentioned in the article. This search can be further enhanced by information contained in a company profile data stored in the system's database record for the company. When the user clicks on a discovered connection the system will take her to the simple search results between user's company and the identified COMPANY or PERSON.

If there are no available connections the system will inform the user of the available service by displaying a link: “Click here to explore your connections to people and companies.” This will take user to the search tool. This may occur when the user or its company is unknown to the system or when there are no connections between the user and the entities mentioned on the page.

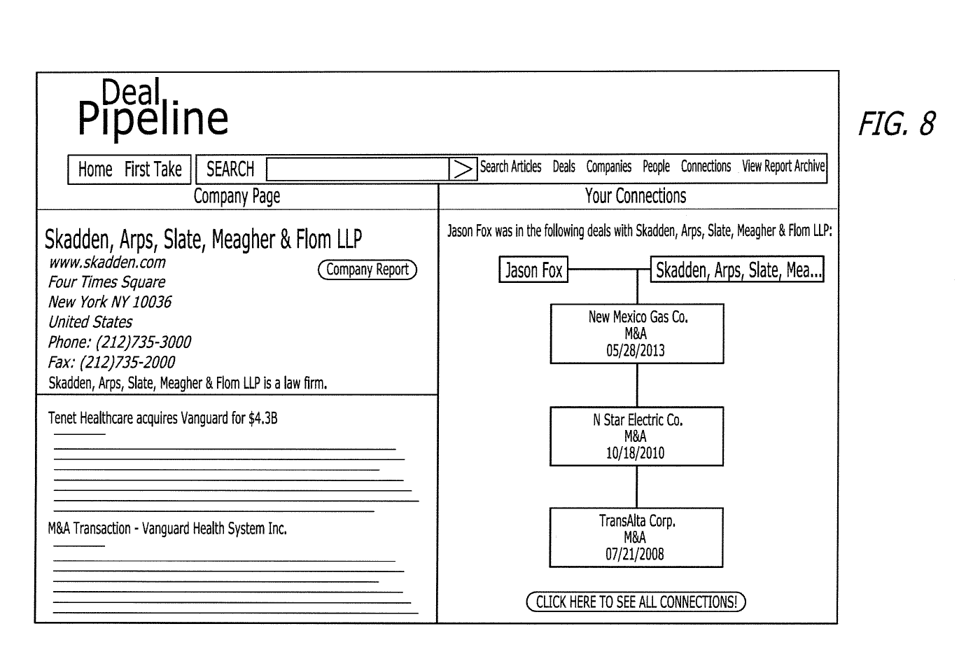

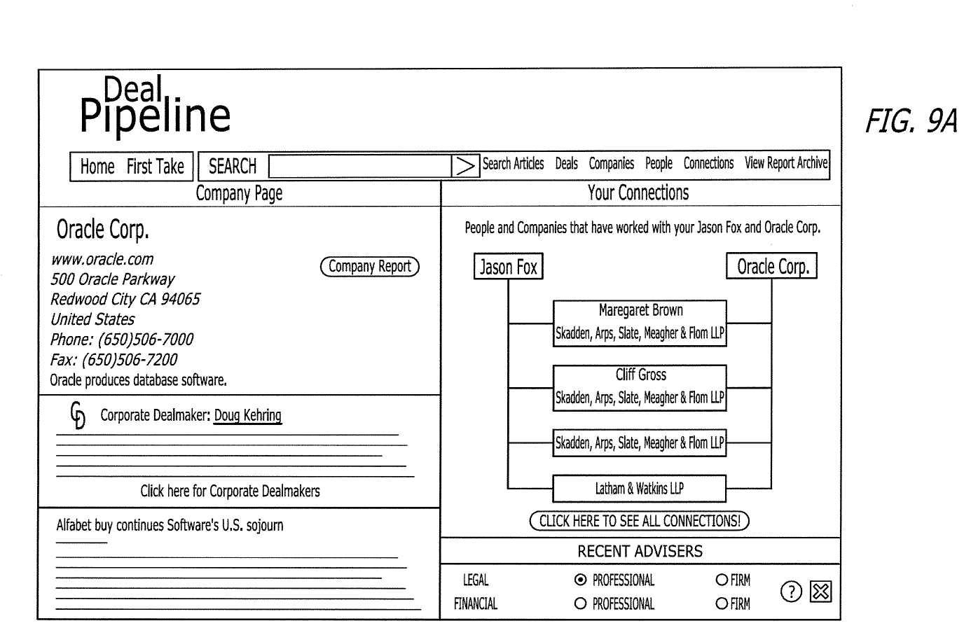

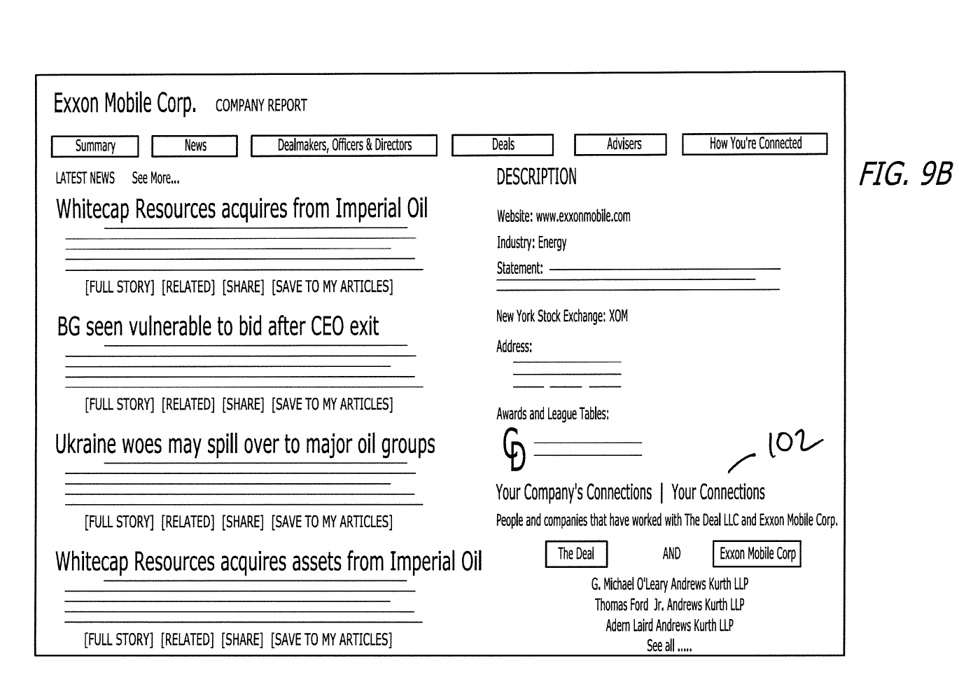

FIGS. 8, 9A and 9B show further embodiments of the Guided Search system. When a user is logged into the system, information from the user's profile is used to populate the “Your Connections” frame shown in FIGS. 8 and 9A. FIG. 9B further shows an optional control 102 to toggle between personal connection and company connections. The new “Your Connections” module on the right-hand side will display any direct or indirect connections. In the case of direct connections, the system will show: “You were in the following deals with [Company name of profile page you're on]”. In FIG. 8 Jason Fox, the user, is connected to Oracle, the company whose profile page is being viewed. The results link to the results page. Text after the results says: “Click here to see all connections!” Clicking takes user to direct connection detailed results.

As shown in FIG. 9A, in the case of an indirect result the text displays: “People and companies that have worked with you and [Company name of profile page you're on].” The results link to the Indirect Detail results page. Text after the results says: “Click here to see all connections!” Clicking takes user to indirect connection Simple results.

If only the user's company information is available to the system, company connections are shown. For example, in the case of direct connections the text of the search boxes is adjusted to state “[User's Company name] was in the following deals with [Company name of profile page you're on]”. The results can optionally show: [Deal], [Deal Type], or [Deal Date].

[Links are provided to link to the Direct Simple results page. Text after results says: “Click here to see all connections!” Clicking takes user to direct connection Detail results.

In the case of Indirect connections the text could state: “People and companies that have worked with [User's Company] and [Company name of profile page you're on].” The results link to the Indirect Detail results page. Text after results says: “Click here to see all connections!” Clicking takes user to indirect connection Simple results.

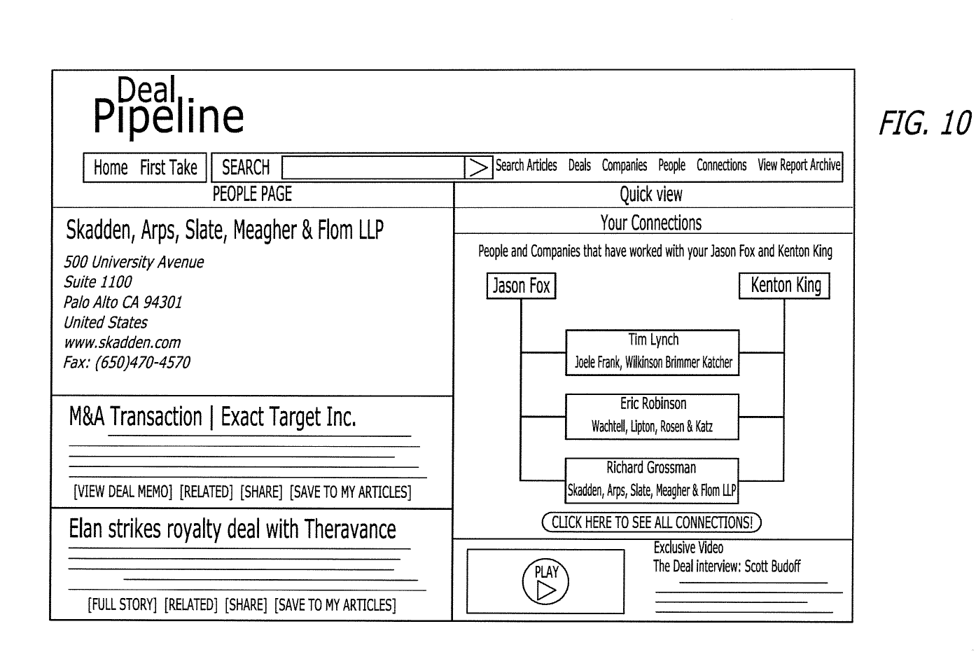

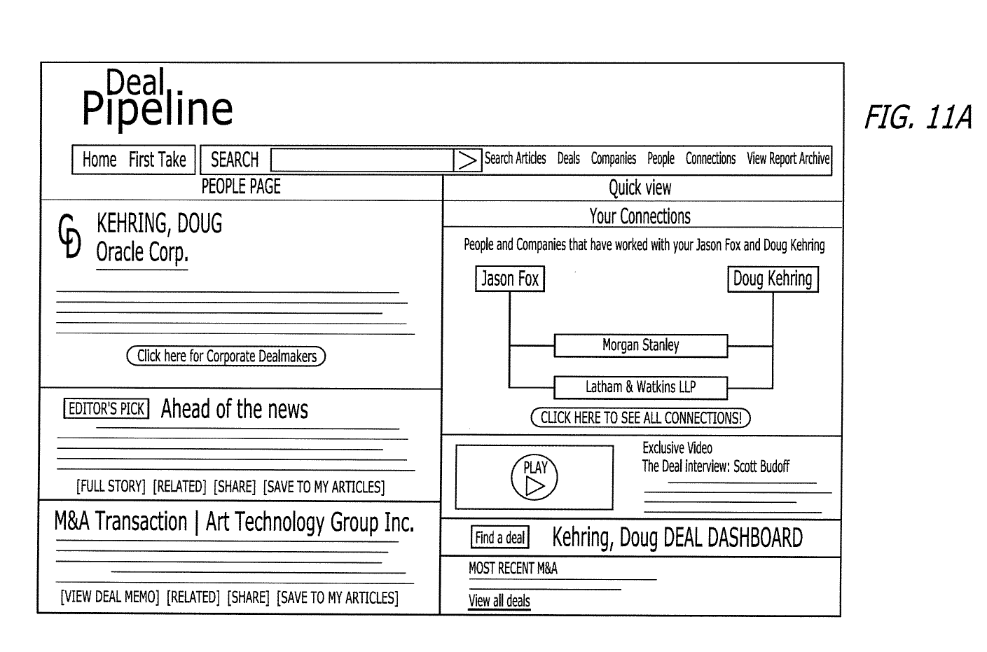

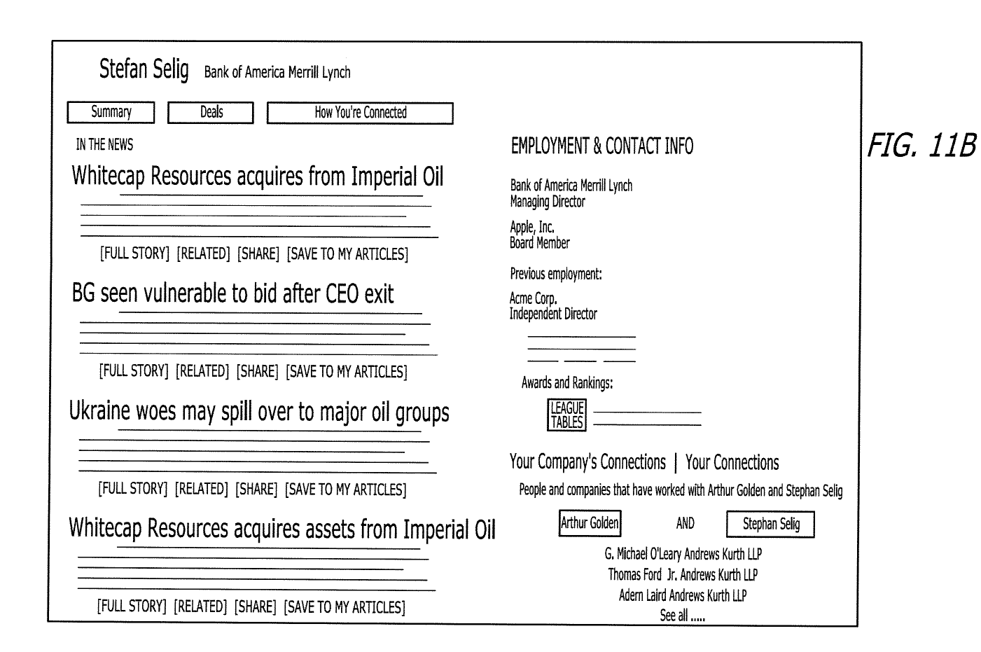

FIGS. 10, 11A and 11B show exemplary embodiments of the Guided Search components for use with people profile pages. Similar to the news article and company profile embodiments described above, a “Your Connections” frame is added to page to view personal profiles. Your Connections displays different information depending on levels of login, and types of Connection Search Results.

When a user is logged on with personal ID, the “Your Connections” module on the right-hand side will display the direct or indirect connections.

If direct connections are available the text displays: “You were in the following deals with [Name of Person profile page you're on]”. Deal details are shown with these data points: [Deal], [Deal Type], or [Deal Date].

The results link to the Direct Simple results page. Text after results says: “Click here to see all connections!” Clicking takes user to direct connection detail results.

If indirect connections are provided the text reads: “People and companies that have worked with you and [Name of Person profile page you're on].” Information about the indirect connections for PEOPLE or COMPANY results is in the format: [Person Name] or [Firm Name]. The results link to the Indirect Detail results page. Text after results says: “Click here to see all connections!” Clicking takes user to indirect connection simple results.

When a user is logged on at the company level, and his company is mapped to company in the database, the new “Your Connections” module on the right-hand side will display the direct or indirect connections.

If direct results are available the text displays: “[Name of user's company] was in the following deals with [Name of Person profile page you're on]”. Information about the deal details are shown with these data points: [Deal}, [Deal Type] or [Deal Date].

The results link to the Direct Simple results page. Text after results says: “Click here to see all connections!” Clicking takes user to direct connection detail results.

If indirect results are available the text reads: “People and companies that have worked with [Name of user's company] and [Name of Person profile page you're on].” Then show first 5 indirect PEOPLE or COMPANY results in this format: [Person Name] or [Firm Name].

The results link to the Indirect Detail results page. Text after results says: “Click here to see all connections!” Clicking takes user to indirect connection Simple results.

A unified database containing profile information about users or companies is provided as a source of information for the system to populate searches.

As shown in the above-described figures, the disclosed system is preferably embodied via a webserver that is accessed by users via a web browser on a client machine. The webserver computer connects to a network, such as the Internet or a LAN, and serves content via the disclosed user interface to client devices as is known in the art. The webserver can run on one physical computer or its function can be distributed over a group of computers working together. The webserver contains logic to format, present, and transmit webpages relevant to the above system. The webserver interfaces with a user collect information as needed above. The webserver further interfaces with a query engine to access the database.

The query engine comprises logic to run structured searches against the database to derive the connections and other data shown in the figures above. For example, the query engine would take two names in a company-company, person-person or company-person search and uses them to craft a series of searches to develop the desired data. First, it would search for deals that would represent a direct connection. This could be accomplished by a simple search of deals with Party 1 and Party 2. Next, it would perform searches for indirect connections. Indirect searches could be accomplished in a number of ways. One option could be to collect a list of all entities that have participated in deals with Party 1 and then run a search for each of them to see if they have participated in deals with Party 2. Alternatively, a list of all entities that have participated in deals with Party 1 can be created and a similar list can be made for Party 2. Next, a search can be performed to look for parties on both lists. Other search strategies will be apparent to persons of skill in the art. Whichever search strategy is employed, it will be transparent to the user, who will just see the result, which are provided to the webserver for integration into the relevant webpage for presentation to the user as shown in the figures.

The query logic could alternately connect to other interface mechanisms to present the information to users. For example, the query engine could interface with a stand-alone PC application or mobile application (or App). Or the query engine could be accessed verbally via a natural language interface and an artificial agent, such as Apple's Siri.

The entirety of this disclosure shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

We claim:

1. A method for implementing a user interface of a connections finder comprising:
presenting an information gathering display interface;
providing on the information gathering display interface a first text entry interface to receive a first party identifier;
providing on the information gathering display interface a second text entry interface to receive a second party identifier;
receiving the first party identifier from the first text entry interface and the second party identifier from the second text entry interfaces;
querying a connections data set to determine whether there are connections between the first party identifier and the second party identifier, wherein the data set contains information pertaining to a plurality of parties and one or more transactions that each of the parties has participated in; and
presenting an information conveying display interface displaying any connections between the first party and the second party determined by the query.

2. The method of claim 1 wherein the presenting steps are embodied through the transmission of HTML data.

3. The method of claim 1 further comprising a check box interface element associated with the first text entry interface to identify whether the first party is a person or a corporate entity.

4. The method of claim 1 further comprising a radio button interface element associated with the first text entry interface to identify whether the first party is a person or a corporate entity.

5. The method of claim 1 wherein the receiving of the first party identifier occurs letter by letter and further comprising presenting an autocomplete interface to display parties matching the letter received.

6. The method of claim 5 wherein the displayed parties are organized by whether the displayed parties are persons or corporate entities.

7. The method of claim 1 wherein the information conveying display interface is presented next to the information gathering display interface.

8. The method of claim 1 wherein the information conveying display interface displays direct connections between the first and second party.

9. The method of claim 1 wherein the information conveying display interface displays indirect connections between the first and second party.

10. The method of claim 1 wherein the information conveying display interface displays a transaction shared by the first and second party.

11. The method of claim 10 wherein the information conveying display interface further displays a role of each party.

12. The method of claim 10 wherein the information conveying display interface displays persons involved in the transaction when the first or second party is a corporation.

13. The method of claim 10 wherein the information conveying display interface further displays a transaction type for the transaction.

14. A system for providing a user interface for a connections finder comprising:
a server configured to:
present an information gathering display interface;
provide on the information gathering display interface a first text entry interface to receive a first party identifier;
provide on the information gathering display interface a second text entry interface to receive a second party identifier;
receive the first party identifier from the first text entry interface and the second party identifier from the second text entry interfaces;
query a connections data set to determine whether there are connections between the first party identifier and the second party identifier, wherein the data set contains information pertaining to a plurality of parties and one or more transactions that each of the parties has participated in; and
present an information conveying display interface displaying any connections between the first party and the second party determined by the query.

15. A method for implementing a user interface of a connections finder comprising:
presenting an information gathering display interface;
providing content on the information gathering display interface;
identifying a viewer of the information gathering display interface;
analyzing the content to identify one or more parties referenced in the content;
querying a connections data set to determine whether there are connections between the viewer and one or more of the parties referenced in the content; and
presenting an information conveying display interface displaying any connections between the viewer and one or more of the parties referenced in the content.

16. The method of claim 15 wherein the information conveying displaying interface identifies one or more transactions in common between viewer and one or more of the parties referenced in the content.

17. The method of claim 15 wherein the analyzing step comprises querying the connections database to identify the parties referenced in the content.

18. A system for providing a user interface for a connections finder comprising:
a server configured to:
present an information gathering display interface;
provide content on the information gathering display interface;
identify a viewer of the information gathering display interface;
analyze the content to identify one or more parties referenced in the content;
query a connections data set to determine whether there are connections between the viewer and one or more of the parties referenced in the content; and
present an information conveying display interface displaying any connections between the viewer and one or more of the parties referenced in the content.
